(19) United States
(12) Patent Application Publication
(10) Pub. No.: US 2015/0182937 A1
(43) Pub. Date: Jul. 2, 2015

(54) LIGHT CONCENTRATING DEVICE FOR PHOTOCHEMICAL REACTION DEVICE

(71) Applicant: Panasonic Intellectual Property Management Co., Ltd., Osaka (JP)

(72) Inventors: RYUTARO FUTAKUCHI, Osaka (JP); MASAKI YAMAMOTO, Nara (JP); YUKA YAMADA, Nara (JP); SATOSHI YOTSUHASHI, Osaka (JP)

(21) Appl. No.: 14/642,770

(22) Filed: Mar. 10, 2015

Related U.S. Application Data
(63) Continuation of application No. PCT/JP2014/003706, filed on Jul. 14, 2014.

(30) Foreign Application Priority Data
Aug. 6, 2013 (JP) 2013-163525

(51) Int. Cl. B01J 19/12; G01N 27/416

(52) U.S. Cl. CPC B01J 19/127; G01N 27/416; B01J 2219/002; B01J 2219/00211; B01J 2219/0024; G02B 19/0014

(57) ABSTRACT

The present disclosure provides a light concentrating device for a photochemical reaction device capable of decreasing abnormal chemical reactions that occur when intensity of sunlight is too strong for an electrode of a photochemical reaction device. The light concentrating device includes a lens for concentrating sunlight on the electrode of the photochemical reaction device, a lens movement device for moving the lens in an optical axis direction, an image pickup device for picking up an image of transmitted sunlight that passes through the electrode, an abnormal chemical reaction detector for detecting presence of an abnormal chemical reaction on the electrode based on information on the image picked up by the image pickup device, and a lens position controller for controlling the lens movement device to move the lens to decrease occurrence of the abnormal chemical reaction when the abnormal chemical reaction detector detects the abnormal chemical reaction.

### BACKGROUND

1. Technical Field

The present disclosure relates to a light concentrating device for a photochemical reaction device used in a photochemical reaction device that produces a photochemical reaction using sunlight.

2. Description of the Related Art

Conventionally, Japanese Patent Application laid-open Publication No. 2001-189470 discloses, in claim 7, a technique of adjusting a light concentration degree by moving a Fresnel lens up and down in a device for stabilizing a temperature of a solar cell. That is, Japanese Patent Application laid-open Publication No. 2001-189470 discloses, in claim 7, a technique of adjusting the light concentration degree while following the sun, and discloses, for example, that the light concentration degree around noon is decreased and the light concentration degree before 9:00 a.m. is increased (see paragraph 0016).

### SUMMARY

However, when the structure described above is applied to a photochemical reaction device instead of a solar cell, there arises a problem that a photochemical reaction cannot be properly produced in the photochemical reaction device.

Therefore, an object of the present disclosure is to provide a light concentrating device for a photochemical reaction device that solves the above problem.

In order to achieve the above object, the present disclosure has the following configurations.

According to one aspect of the present disclosure, there is provided a light concentrating device for a photochemical reaction device including a lens configured to concentrate sunlight on an electrode of the photochemical reaction device, a lens movement device configured to move the lens in an optical axis direction, a photochemical reaction information acquisition unit configured to acquire information regarding a photochemical reaction that occurs on the electrode of the photochemical reaction device, an abnormal chemical reaction detector configured to detect presence of an abnormal chemical reaction on the electrode based on the information regarding the photochemical reaction acquired by the photochemical reaction information acquisition unit, and a lens position controller configured to control the lens movement device to move the lens so as to decrease occurrence of the abnormal chemical reaction when the abnormal chemical reaction detector detects the abnormal chemical reaction.

Part of these general and specific aspects may be implemented by a system, a method, a computer program, and an arbitrary combination of the system, the method, and the computer program.

According to the above aspect of the present disclosure, the lens position controller controls the lens movement device to move the lens so as to decrease occurrence of the abnormal chemical reaction when the abnormal chemical reaction detector detects the abnormal chemical reaction. Thus, it is possible to properly produce the photochemical reaction in the photochemical reaction device.

### BRIEF DESCRIPTION OF DRAWINGS

FIG. 1A is a schematic illustrative diagram of a light concentrating device for a photochemical reaction device according to a first embodiment of the present disclosure;

FIG. 1B is a schematic illustrative diagram of a light concentrating device for a photochemical reaction device according to a variation of the first embodiment of the present disclosure;

FIG. 2 is a detailed block diagram of the light concentrating device for a photochemical reaction device;

FIG. 3 is an illustrative diagram illustrating a part of the light concentrating device for a photochemical reaction device;

FIG. 4 is an illustrative diagram of a device for reducing carbon dioxide as an example of a photochemical reaction device that can be used in the light concentrating device for a photochemical reaction device according to the first embodiment;

FIG. 5A is an illustrative diagram illustrating a counter electrode in which metallic wiring is not formed in the device for reducing carbon dioxide illustrated in FIG. 4;

FIG. 5B is an illustrative diagram illustrating the counter electrode in which a plurality of pieces of linear metallic wiring are formed in the device illustrated in FIG. 4;

FIG. 5C is an illustrative diagram illustrating the counter electrode in which a plurality of pieces of linear metallic wiring that have a mesh shape are formed in the device illustrated in FIG. 4;

FIG. 5D is an enlarged cross-sectional view of an anode electrode (photochemical electrode) as one specific example of the counter electrode in the device illustrated in FIG. 4;

FIG. 5E is an enlarged cross-sectional view of an anode electrode (photochemical electrode) as another specific example of the counter electrode in the device illustrated in FIG. 4;

FIG. 5F is an enlarged cross-sectional view of an anode electrode (photochemical electrode) as still another example of the counter electrode illustrated in FIG. 5D;

FIG. 5G is an enlarged cross-sectional view of an anode electrode (photochemical electrode) as still another example of the counter electrode illustrated in FIG. 5E;

FIG. 6 is a flow chart for describing a light concentrating method for a photochemical reaction device performed by the light concentrating device for a photochemical reaction device according to the first embodiment of the present disclosure;

FIG. 7A is a detailed block diagram of a light concentrating device for a photochemical reaction device according to a second embodiment of the present disclosure;

FIG. 7B is an illustrative diagram for describing a state where a spot moves randomly in the light concentrating device for a photochemical reaction device according to the second embodiment of the present disclosure;

FIG. 8A is a front view of a tracking mechanism of the light concentrating device for a photochemical reaction device according to the second embodiment of the present disclosure;

FIG. 8B is a side view of the tracking mechanism of the light concentrating device for a photochemical reaction device according to the second embodiment of the present disclosure;

FIG. 9 is a flow chart for describing a light concentrating method for a photochemical reaction device performed by the light concentrating device for a photochemical reaction device according to the second embodiment of the present disclosure;

FIG. 10 is a detailed block diagram of a light concentrating device for a photochemical reaction device according to a third embodiment of the present disclosure; and

FIG. 11 is a flow chart for describing a light concentrating method for a photochemical reaction device performed by the light concentrating device for a photochemical reaction device according to the third embodiment of the present disclosure.

### DETAILED DESCRIPTION OF THE EMBODIMENTS

### Findings Resulting in the Present Disclosure

Application of a structure described in PTL 1 to a photochemical reaction device instead of a solar cell may cause the following problem. That is, when a lens is moved to concentrate sunlight on an anode electrode of the photochemical reaction device, it is possible to make adjustment to make a light concentration degree constant, but it is not possible to lower the light concentration degree when intensity of sunlight is too strong for the electrode. For example, when weather changes from cloudy to fine and the intensity of sunlight is too strong for the electrode, all electrons generated in the anode electrode do not flow into a cathode electrode, resulting in excessive built-up of electrons in the anode electrode. This causes an abnormal chemical reaction to occur in the anode electrode itself, and a problem may arise that the electrode begins to melt.

Therefore, an object of the present disclosure is to solve the above-described problem, and to provide a light concentrating device for a photochemical reaction device capable of decreasing abnormal chemical reactions that occur when intensity of sunlight is too strong for the electrode of the photochemical reaction device.

Embodiments of the present disclosure will be described in detail below with reference to the drawings.

Before the description of the embodiments of the present disclosure in detail with reference to the drawings, various aspects of the present disclosure will be described.

According to a first aspect of the present disclosure, there is provided a light concentrating device for a photochemical reaction device including:

a lens configured to concentrate sunlight on an electrode of a photochemical reaction device;

a lens movement device configured to move the lens in an optical axis direction;

a photochemical reaction information acquisition unit configured to acquire information regarding a photochemical reaction that occurs on the electrode of the photochemical reaction device;

an abnormal chemical reaction detector configured to detect presence of an abnormal chemical reaction on the electrode based on the information regarding the photochemical reaction acquired by the photochemical reaction information acquisition unit; and

a lens position controller configured to control the lens movement device to move the lens so as to decrease occurrence of the abnormal chemical reaction when the abnormal chemical reaction detector detects the abnormal chemical reaction.

According to the above first aspect, the lens position controller controls the lens movement device to move the lens so as to decrease occurrence of the abnormal chemical reaction when the abnormal chemical reaction detector detects the abnormal chemical reaction. Thus, it is possible to properly produce the photochemical reaction in the photochemical reaction device. Specifically, it is possible to decrease the abnormal chemical reaction that occurs when intensity of sunlight is too strong for the electrode of the photochemical reaction device.

According to a second aspect of the present disclosure, there is provided the light concentrating device for a photochemical reaction device according to the first aspect, wherein

the photochemical reaction information acquisition unit is formed of an image pickup device configured to pick up an image of the sunlight concentrated on the electrode and to acquire information on the picked-up image of the sunlight as information regarding the photochemical reaction,

the abnormal chemical reaction detector includes:
a light intensity distribution detector configured to detect light intensity distribution of the sunlight based on the information on the image picked up by the image pickup device; and
a determination unit configured to determine whether peak intensity of the light intensity distribution detected by the light intensity distribution detector exceeds a peak intensity threshold, and

when the determination unit determines that the peak intensity of the light intensity distribution exceeds the peak intensity threshold, the abnormal chemical reaction detector determines that the abnormal chemical reaction is detected, and the lens position controller controls the lens movement device to move the lens so as to decrease the peak intensity of the light intensity distribution.

According to the above second aspect, use of the image pickup device as the photochemical reaction information acquisition unit makes it possible to directly read sunlight irradiation condition, to predict occurrence of the abnormal chemical reaction in advance, and to perform quick communication of information to the determination unit.

According to a third aspect of the present disclosure, there is provided the light concentrating device for a photochemical reaction device according to the first aspect, wherein

the photochemical reaction information acquisition unit is formed of an ammeter for measuring a current value that occurs on the electrode to acquire the measured current value as the information regarding the photochemical reaction,

the abnormal chemical reaction detector includes a determination unit configured to determine whether the current value measured by the ammeter exceeds a current value threshold, and

when the determination unit determines that the current value exceeds the current value threshold, the abnormal chemical reaction detector determines that the abnormal chemical reaction is detected, and the lens position controller controls the lens movement device to move the lens so as to decrease the current value.

According to the above third aspect, use of the ammeter as the photochemical reaction information acquisition unit makes it possible to directly know the abnormal chemical reaction condition, and to perform secure communication of information to the determination unit.

According to a fourth aspect of the present disclosure, there is provided the light concentrating device for a photochemical reaction device according to the second aspect, wherein

the abnormal chemical reaction detector further includes a spot size calculator configured to calculate a spot size of the sunlight on the electrode based on the information on the image picked up by the image pickup device, and

when the determination unit determines that the peak intensity of the light intensity distribution exceeds the peak intensity threshold, the abnormal chemical reaction detector determines that the abnormal chemical reaction is detected, and the lens position controller controls the lens movement device to move the lens so as to decrease the peak intensity of the light intensity distribution such that the spot size of the sunlight on the electrode becomes larger than the calculated spot size.

According to the above fourth aspect, since the abnormal chemical reaction detector further includes the spot size calculator, it is possible to calculate the spot size that provides appropriate peak intensity from a relationship between the peak intensity and the spot size, to calculate an appropriate lens moving distance immediately from a relationship between the spot size and a lens position, and to always maintain the lens position that provides a normal chemical reaction.

According to a fifth aspect of the present disclosure, there is provided the light concentrating device for a photochemical reaction device according to any one of first to fourth aspects, further including:

a tracking mechanism configured to support the photochemical reaction device, the lens, and the lens movement device, and to move an elevation angle and an azimuth angle in alignment with a position of the sun;

a tracking mechanism controller configured to control an operation of the tracking mechanism to move the elevation angle and azimuth angle of the tracking mechanism so as to align the photochemical reaction device, the lens, and the lens movement device with the position of the sun; and

a spot position controller configured to control the operation of the tracking mechanism via the tracking mechanism controller to move the elevation angle and azimuth angle of the tracking mechanism such that a spot of the sunlight of the sun on the electrode moves within an effective reaction region of the electrode of the photochemical reaction device.

According to the above fifth aspect, by movement of the spot of the sunlight with time rather than the spot always disposed in an identical position within the effective reaction region of the electrode, chemical reactions occur not only in a specific position within the effective reaction region of the electrode, but chemical reactions occur uniformly within the effective reaction region. This can extend a life of the electrode.

According to a sixth aspect of the present disclosure, there is provided the light concentrating device for a photochemical reaction device according to the fifth aspect, wherein the spot position controller moves the spot of the sunlight of the sun on the electrode randomly or spirally within the effective reaction region of the electrode.

According to the above sixth aspect, by movement of the spot of the sunlight with time rather than the spot always disposed in an identical position within the effective reaction region of the electrode, chemical reactions occur not only in a specific position within the effective reaction region of the electrode, but chemical reactions occur uniformly within the effective reaction region. This can extend a life of the electrode.

According to a seventh aspect of the present disclosure, there is provided non-transitory computer-readable recording medium having stored thereon a control program for controlling an operation of a light concentrating device for a photochemical reaction device,

the light concentrating device for a photochemical reaction device including:
a lens configured to concentrate sunlight on an electrode of the photochemical reaction device;
a lens movement device configured to move the lens in an optical axis direction; and
a photochemical reaction information acquisition unit configured to acquire information regarding a photochemical reaction that occurs on the electrode of the photochemical reaction device,

the control program causing a computer to function as:

an abnormal chemical reaction detector configured to detect presence of an abnormal chemical reaction on the electrode based on the information regarding the photochemical reaction acquired by the photochemical reaction information acquisition unit; and

a lens position controller configured to control the lens movement device to move the lens so as to decrease occurrence of the abnormal chemical reaction when the abnormal chemical reaction detector detects the abnormal chemical reaction.

According to the above seventh aspect, the lens position controller controls the lens movement device to move the lens so as to decrease occurrence of the abnormal chemical reaction when the abnormal chemical reaction detector detects the abnormal chemical reaction. Thus, it is possible to properly produce the photochemical reaction in the photochemical reaction device. Specifically, it is possible to decrease the abnormal chemical reaction that occurs when the intensity of the sunlight is too strong for the electrode of the photochemical reaction device.

A first embodiment of the present disclosure will be described in detail below with reference to the drawings.

### First Embodiment

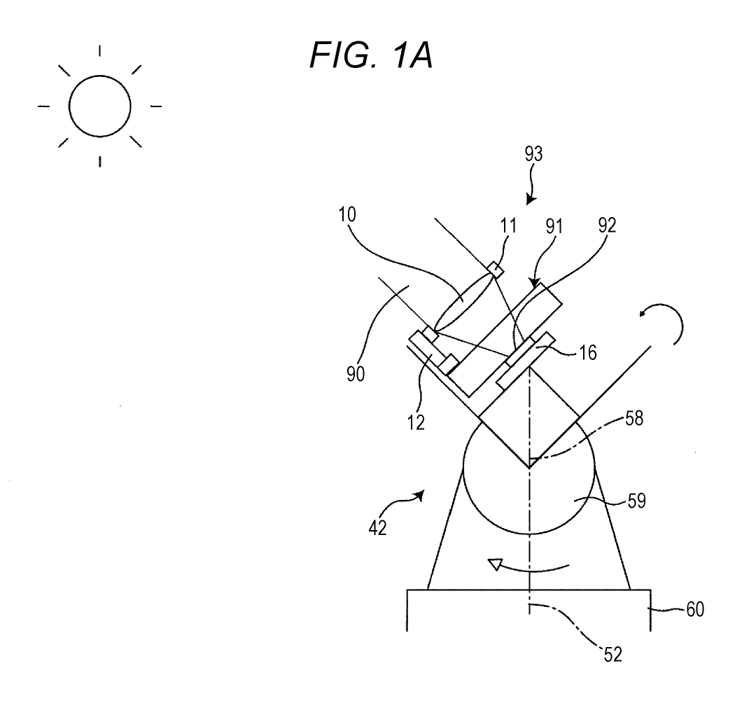

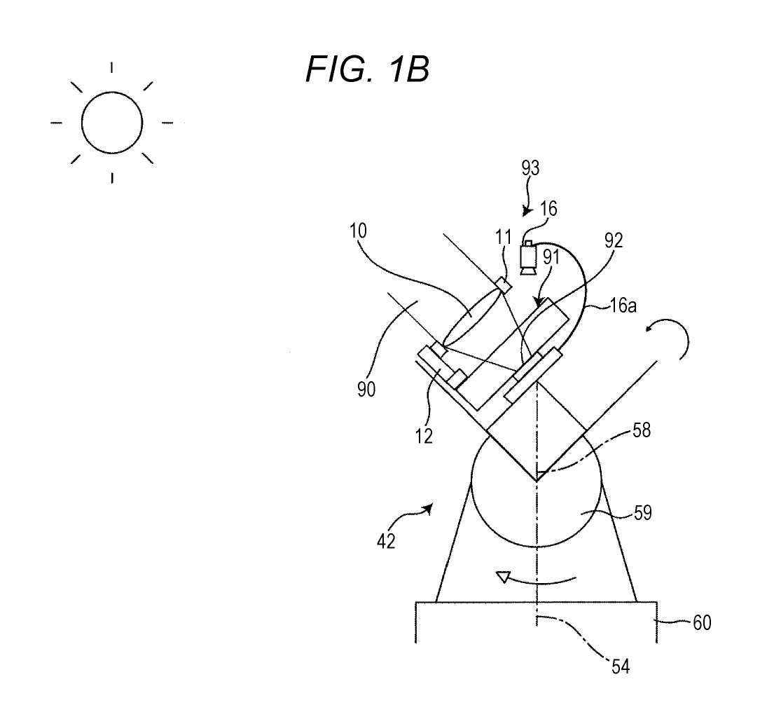

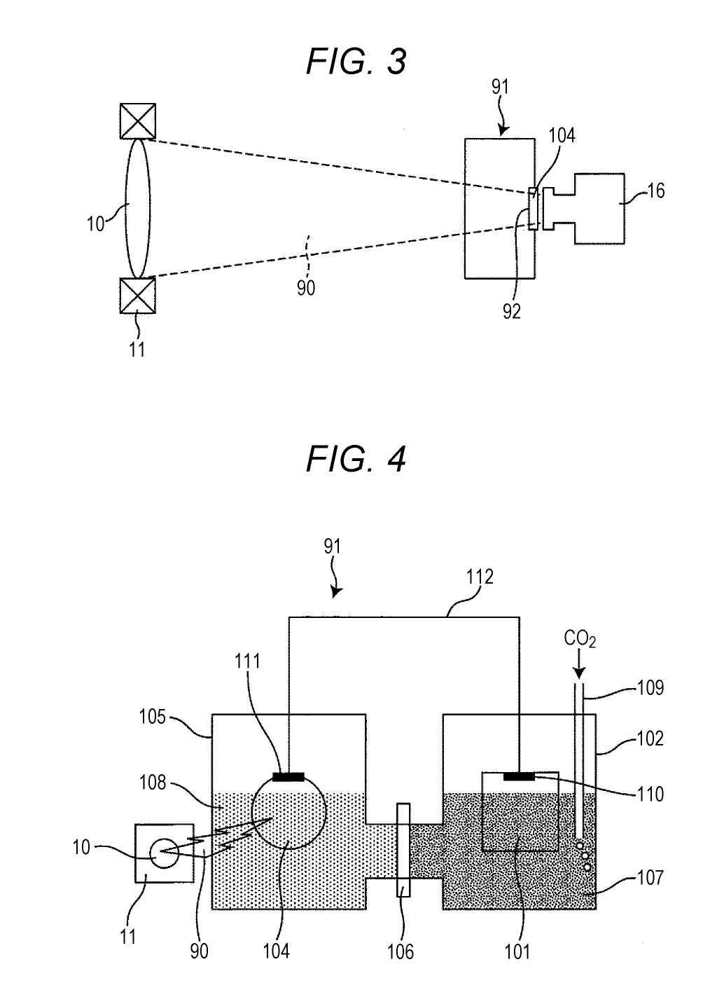

A light concentrating device for a photochemical reaction device according to a first embodiment of the present disclosure includes at least lens 10, lens movement device 25, photochemical reaction information acquisition unit, abnormal chemical reaction detector 20, and lens position controller 22, as illustrated in FIG. 1A to FIG. 3.

Light concentrating lens 10, such as a Fresnel lens, concentrates sunlight 90 on electrode 104 of photochemical reaction device 91 described later.

Lens movement device 25 moves light concentrating lens 10 forward and backward in optical axis direction Z. Lens movement device 25 includes lens holder 11 having junction part 11a, screw shaft 12, motor 13, and encoder 15.

Light concentrating lens 10 is retained by lens holder 11. Lens holder 11 has junction part 11a that is processed in a nut shape at one end, and junction part 11a is screwed in screw shaft 12 that has an axial direction parallel to optical axis direction Z of lens 10. Screw shaft 12 is connected to a rotation shaft of motor 13 through coupling 14, and screw shaft 12 is rotated forwardly and reversely by the rotation shaft of motor 13 being rotatively driven in a forward and reverse direction. When screw shaft 12 is rotated forwardly and reversely, junction part 11a of lens holder 11 moves forward and backward with respect to screw shaft 12 in the axial direction of screw shaft 12, that is, in optical axis direction Z of the lens, and lens 10 moves forward and backward in optical axis direction Z of the lens. Encoder 15 is connected to the rotation shaft of motor 13, and encoder 15 detects a rotation angle of the rotation shaft of motor 13 and outputs the rotation angle to lens position controller 22 described later as an encoder signal.

The photochemical reaction information acquisition unit acquires information regarding a photochemical reaction that occurs in electrode 104 of photochemical reaction device 91. An example of the photochemical reaction information acquisition unit includes an image pickup device. A specific example of the image pickup device includes camera 16. Camera 16 picks up an image of transmitted light 92 that passes through electrode 104 of photochemical reaction device 91, acquires image data, and outputs the image data to abnormal chemical reaction detector 20.

Chemical reaction abnormality detector 20 includes, for example, light intensity distribution detector 17, spot size calculator 18, and determination unit 19.

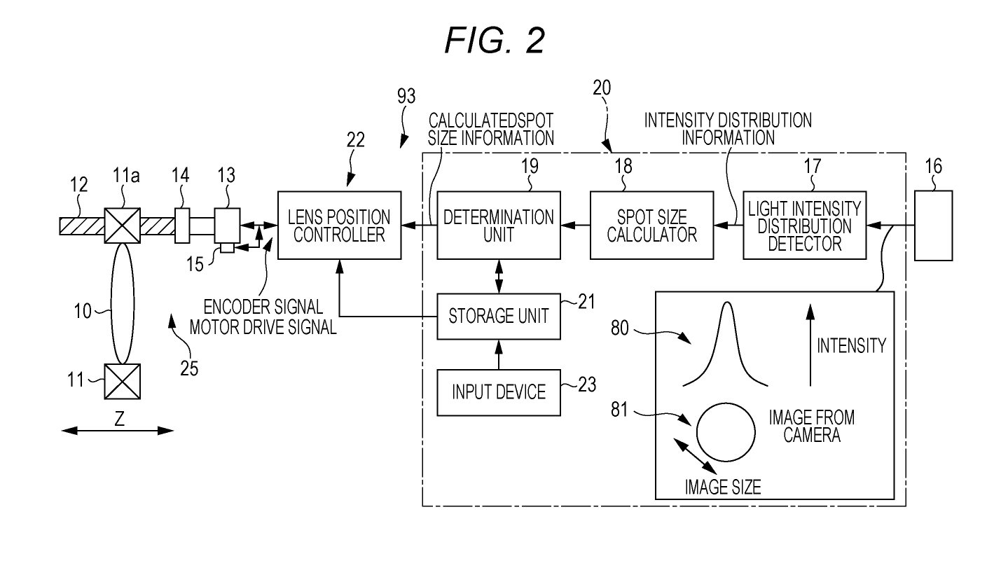

Light intensity distribution detector 17 receives input of the image data picked up by camera 16, and determines peak intensity (maximum light intensity) of light intensity distribution as a light intensity measurement Iₘₑₛ based on the image data. Specifically, light intensity distribution detector 17 detects the peak intensity by observing transmitted light 92 that passes through electrode 104 with camera 16. Information on the light intensity distribution detected by light intensity distribution detector 17 is output to spot size calculator 18. Graph 80 of FIG. 2 illustrates an example of observation of the light intensity distribution. A horizontal axis of graph 80 represents a position of a spot of transmitted light 92, a vertical axis represents light intensity, and a greatest height is the peak intensity (maximum light intensity), that is, the light intensity measurement Iₘₑₛ.

Spot size calculator 18 calculates an outside diameter, that is, a spot size of transmitted light 92 that passes through electrode 104 based on the information on the light intensity distribution detected by light intensity distribution detector 17, and outputs a calculation result to determination unit 19. Circle 81 of FIG. 2 illustrates an example of observation of the spot. A diameter of circle 81 is the spot size.

Determination unit 19 determines whether the peak intensity of the light intensity distribution detected by light intensity distribution detector 17 exceeds a peak intensity threshold. When determination unit 19 determines that the detected peak intensity of the light intensity distribution exceeds the peak intensity threshold, determination unit 19 outputs a determination result to lens position controller 22.

Lens position controller 22 calculates a position of lens 10 in which the spot size becomes larger than the spot size calculated by spot size calculator 18 such that the peak intensity of the light intensity distribution becomes weaker. Here, a graph or table that represents a relationship among an amount of lens movement, the light intensity, and the spot size is created and stored in storage unit 21 in advance. Lens position controller 22 calculates the position of lens 10 in which the peak intensity of the light intensity distribution becomes weaker as a target value by referring to the graph or table in storage unit 21. Meanwhile, lens position controller 22 calculates the position of lens 10 at a time of measurement, from the spot size that is calculated by spot size calculator 18, a screw pitch of screw shaft 12, and information on a resolution and the rotation angle of encoder 15. Therefore, lens position controller 22 calculates a difference between the position of lens 10 at a time of measurement and the position of lens 10 calculated as the target value, that is, the amount of lens movement. Lens position controller 22 then outputs the amount of lens movement to motor 13 as a motor drive signal to drive and control motor 13. As result of the drive and control, motor 13 causes screw shaft 12 to rotate, thereby moving lens 10 in optical axis direction Z to the position of lens 10 that is the target value. Accordingly, the peak intensity of the light intensity distribution becomes weaker, and the abnormal chemical reaction in electrode 104 is decreased.

Examples of photochemical reaction device 91 that can use light concentrating device 93 for a photochemical reaction device include a device for reducing carbon dioxide.

FIG. 4 illustrates the device for reducing carbon dioxide as an example of photochemical reaction device 91 according to the first embodiment. The device includes cathode compartment 102, anode compartment 105, and solid electrolyte membrane 106.

Cathode compartment 102 includes working electrode 101.

Working electrode 101 is in contact with first electrolytic solution 107. Specifically, working electrode 101 is immersed in first electrolytic solution 107.

Examples of a material for working electrode 101 include copper, gold, silver, cadmium, indium, tin, lead, or an alloy of these metals. A preferred example of the material for working electrode 101 is copper. In order to increase an amount of formic acid, an example of the material for working electrode 101 is indium. Another example of the material for working electrode 101 is a metallic compound that can reduce carbon dioxide. As long as the material is in contact with first electrolytic solution 107, only a part of working electrode 101 may be immersed in first electrolytic solution 107.

Anode compartment 105 includes counter electrode (electrode on an anode side) 104.

Counter electrode 104 is in contact with second electrolytic solution 108. Specifically, counter electrode 104 is immersed in second electrolytic solution 108.

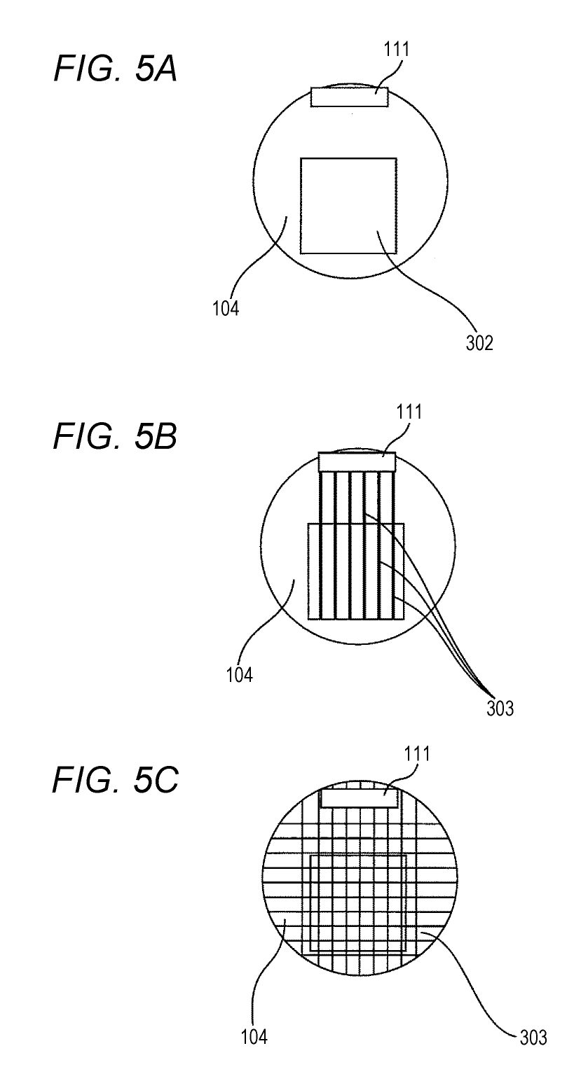

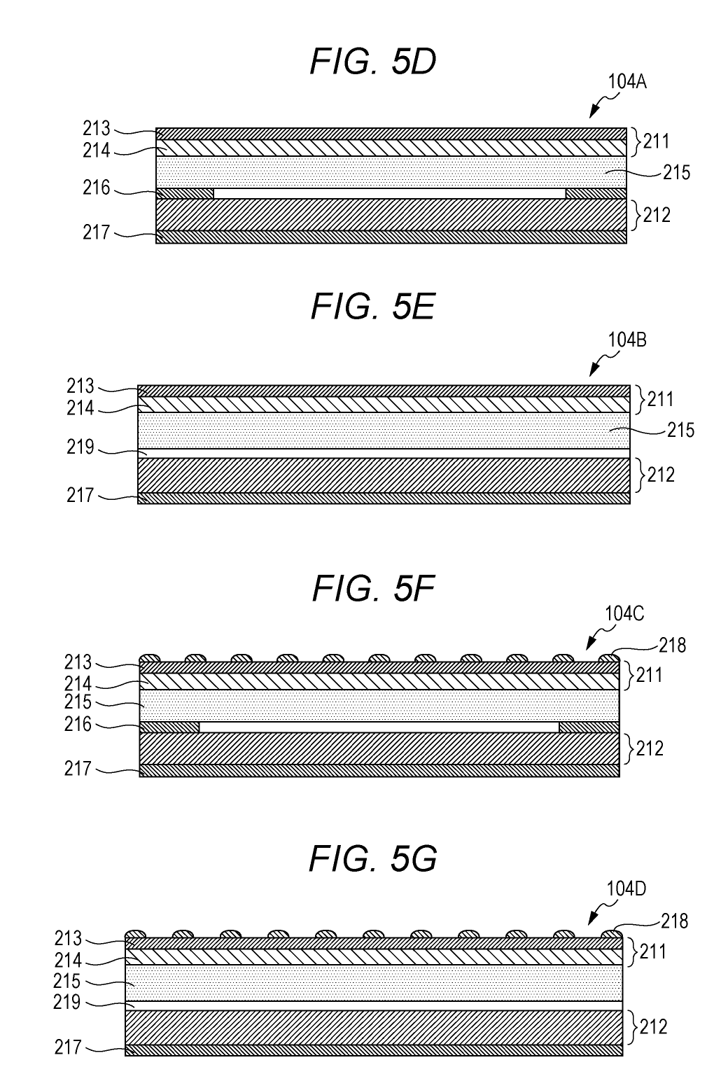

Counter electrode 104 includes on its surface nitride semiconductor region (effective reaction region) 302 formed of a nitride semiconductor, as illustrated in FIG. 5A. The nitride semiconductor is preferably gallium nitride or aluminum gallium nitride. In FIG. 5A, square nitride semiconductor region 302 is formed on a part of the surface of counter electrode 104. However, nitride semiconductor region 302 may be formed on the entire surface of counter electrode 104. A shape of nitride semiconductor region 302 is not limited to the square.

As illustrated in FIG. 5B and FIG. 5C, metallic wiring 303 is provided in nitride semiconductor region 302 as an example. Metallic wiring 303 is in contact with nitride semiconductor region 302 as an example. Nitride semiconductor region 302 is irradiated with sunlight 90 through lens 10. Metallic wiring 303 is also irradiated with sunlight 90.

As illustrated in FIG. 5B, a plurality of pieces of metallic wiring 303 may be provided. Each piece of metallic wiring 303 is linear. The plurality of pieces of metallic wiring 303 are parallel to each other.

As illustrated in FIG. 5C, a plurality of pieces of metallic wiring 303 that have a mesh shape may be provided. A shape of metallic wiring 303 is not particularly limited.

Metallic wiring 303 may form an ohmic contact with a nitride semiconductor as an example. An example of a material for metallic wiring 303 includes titanium. Specifically, metallic wiring 303 is titanium wiring, titanium/nickel laminated wiring, titanium/aluminum laminated wiring, titanium/gold laminated wiring, or titanium/silver laminated wiring. A preferred example of the material for metallic wiring 303 includes titanium/nickel laminated wiring.

As long as the nitride semiconductor is in contact with second electrolytic solution 108, only a part of counter electrode 104 may be immersed in second electrolytic solution 108.

An example of counter electrode 104 will be described.

FIG. 5D illustrates a basic structure of anode electrode (photochemical electrode) 104A as an example of counter electrode 104. Anode electrode 104A has a structure of lamination of first semiconductor layer 211 formed of a nitride semiconductor material, conductive base material 215, and second semiconductor layer 212 that has a pn junction structure, in order from a surface side that is irradiated with sunlight. In addition to the above structure, anode electrode 104A has electrode part 216 that electrically connects conductive base material 215 to second semiconductor layer 212, and terminal electrode part 217.

First semiconductor layer 211 includes AlₓGa₁₋ₓN layer (0≦x≦0.25, hereinafter referred to as “AlGaN layer”) 213, and n-type GaN layer (hereinafter referred to as “n-GaN layer”) 214.

Second semiconductor layer 212 has a pn junction structure, and is electrically connected to an n-GaN layer 214 side of first semiconductor layer 211 via a p-type semiconductor layer.

Although a method for producing anode electrode 104A is not limited, typically method 1 and method 2 below are available.

In method 1, to begin with, first semiconductor layer 211 is formed on one surface of conductive base material 215 that serves as a base, in order of n-GaN layer 214 and AlGaN layer 213. Next, second semiconductor layer 212 having a pn junction structure is formed on the other surface of conductive base material 215 with electrode part 216 interposed therebetween. The p-type semiconductor layer of second semiconductor layer 212 is formed to become an electrode part 216 side. Subsequently, terminal electrode part 217 is added to an n-type semiconductor layer of second semiconductor layer 212. In this manner, anode electrode 104A can be produced.

In method 2, to begin with, first semiconductor layer 211 is formed on one surface of conductive base material 215 that serves as a base, in order of n-GaN layer 214 and AlGaN layer 213. Next, a separately produced structure is electrically connected to the other surface of conductive base material 215 via electrode part 216, the structure being made of second semiconductor layer 212 that has a pn junction structure. Subsequently, terminal electrode part 217 is added to an n-type semiconductor layer of second semiconductor layer 212. In this manner, anode electrode 104A can be produced. In anode electrode 104A produced by method 2, electrode part 216 is provided in a part of the other surface of conductive base material 215 and a surface of a p-type semiconductor layer of second semiconductor layer 212.

Terminal electrode part 217 is a connection terminal for anode electrode 104A, and is connected to a cathode electrode through a lead wire. At this time, anode electrode 104A is electrically connected to the cathode electrode, without via an external power source, such as a potentiostat.

First semiconductor layer 211 that is made of a nitride semiconductor and forms anode electrode 104A is typically formed as a thin film. A formation method thereof is not particularly limited as long as the method is capable of forming the thin film of the nitride semiconductor on conductive base material 215. An example of the method is an organic metal vapor phase epitaxy method.

Conductive base material 215 has light-transmissive in consideration of the need for irradiating second semiconductor layer 212 with light. Examples of the material for conductive base material 215 include a low-resistance single crystal gallium nitride (GaN) material, a gallium oxide (Ga₂O₃) material, a silicon carbide (SiC) material, and a zinc oxide (ZnO) material.

Electrode part 216 is a thin-film metal layer and is produced by, for example, a vacuum evaporation method. When conductive base material 215 can be electrically connected to second semiconductor layer 212 without a loss, electrode part 216 may be omitted, and conductive base material 215 may be directly connected to second semiconductor layer 212.

FIG. 5E is a cross-sectional view illustrating anode electrode 104B as another example of counter electrode 104 in which first semiconductor layer 211 and second semiconductor layer 212 are joined with transparent conductive layer 219 interposed therebetween instead of electrode part 216 illustrated in FIG. 5D. A configuration of a connection part is not limited as long as the anode electrode has a configuration in which first semiconductor layer 211 is electrically connected to second semiconductor layer 212, and second semiconductor layer 212 is irradiated with light that passes through first semiconductor layer 211.

Moreover, in order to increase oxygen generation efficiency and durability of anode electrodes 104A and 104B, a plurality of nickel oxide particles 218 may be distributed on a surface of AlGaN layer 213, as illustrated as anode electrode 104C in FIG. 5F and anode electrode 104D in FIG. 5G.

First electrolytic solution 107 is retained inside cathode compartment 102. Second electrolytic solution 108 is retained inside anode compartment 105.

Examples of first electrolytic solution 107 include a potassium hydrogencarbonate aqueous solution, a sodium hydrogencarbonate aqueous solution, a potassium chloride aqueous solution, a potassium sulfate aqueous solution, and a potassium phosphate aqueous solution. A preferred example of first electrolytic solution 107 is a potassium hydrogencarbonate aqueous solution. As one example, first electrolytic solution 107 is slightly acidic in a state where carbon dioxide dissolves in first electrolytic solution 107.

An example of second electrolytic aqueous solution 108 is a sodium hydroxide solution and a potassium hydroxide aqueous solution. A preferred example of second electrolytic solution 108 is a sodium hydroxide aqueous solution. As one example, second electrolytic aqueous solution 108 is strongly basic.

A solute of first electrolytic solution 107 and a solute of second electrolytic solution 108 may be identical or may differ from each other.

First electrolytic solution 107 contains carbon dioxide. A concentration of carbon dioxide is not particularly limited.

In order to separate first electrolytic solution 107 from second electrolytic solution 108, solid electrolyte membrane 106 is sandwiched between cathode compartment 102 and anode compartment 105. That is, in the present device, first electrolytic solution 107 and second electrolytic solution 108 do not mix with each other.

Solid electrolyte membrane 106 is not particularly limited as long as only protons can pass and other substances cannot pass through solid electrolyte membrane 106. An example of solid electrolyte membrane 106 is Nafion (registered trademark).

Working electrode 101 includes working electrode terminal 110. Counter electrode 104 includes counter electrode terminal 111.

Working electrode terminal 110 is electrically connected to counter electrode terminal 111 through lead wire 112. That is, working electrode 101 is electrically connected to counter electrode 104 through lead wire 112. As illustrated in FIG. 5B and FIG. 5C, metallic wiring 303 is electrically connected to counter electrode terminal 111. In the present device, a power source is not electrically inserted between working electrode 101 and counter electrode 104. Examples of the power source include a battery and a potentiostat.

### (Reduction Method of Carbon Dioxide)

Next, a method for reducing carbon dioxide by using the above-mentioned device will be described.

A carbon dioxide reduction device may be placed at room temperatures and atmospheric pressures.

As illustrated in FIG. 4, counter electrode 104 is irradiated with sunlight 90 through lens 10. At least a part of counter electrode 104 is irradiated with sunlight 90. Entire counter electrode 104 may be irradiated with sunlight 90. Working electrode 101 is not irradiated with sunlight 90.

Metallic wiring 303 may be provided on a surface of nitride semiconductor region 302. That is, metallic wiring 303 and nitride semiconductor region 302 are irradiated with sunlight 90. Moreover, metallic wiring 303 is covered with, as an example, an insulating material (not illustrated).

As illustrated in FIG. 4, the present device includes, as an example, pipe 109 that has an upper end communicating with outside air. As an example, carbon dioxide contained in first electrolytic solution 107 is reduced while carbon dioxide is supplied from outside air through pipe 109 to first electrolytic solution 107. A lower end of pipe 109 is immersed in first electrolytic solution 107. As another example, it is also possible to dissolve sufficient amount of carbon dioxide in first electrolytic solution 107 by supplying carbon dioxide through pipe 109 before reduction of carbon dioxide starts.

When working electrode 101 includes a metal such as copper, gold, silver, cadmium, indium, tin, or lead, carbon dioxide contained in first electrolytic solution 107 can be reduced to generate carbon monoxide or formic acid.

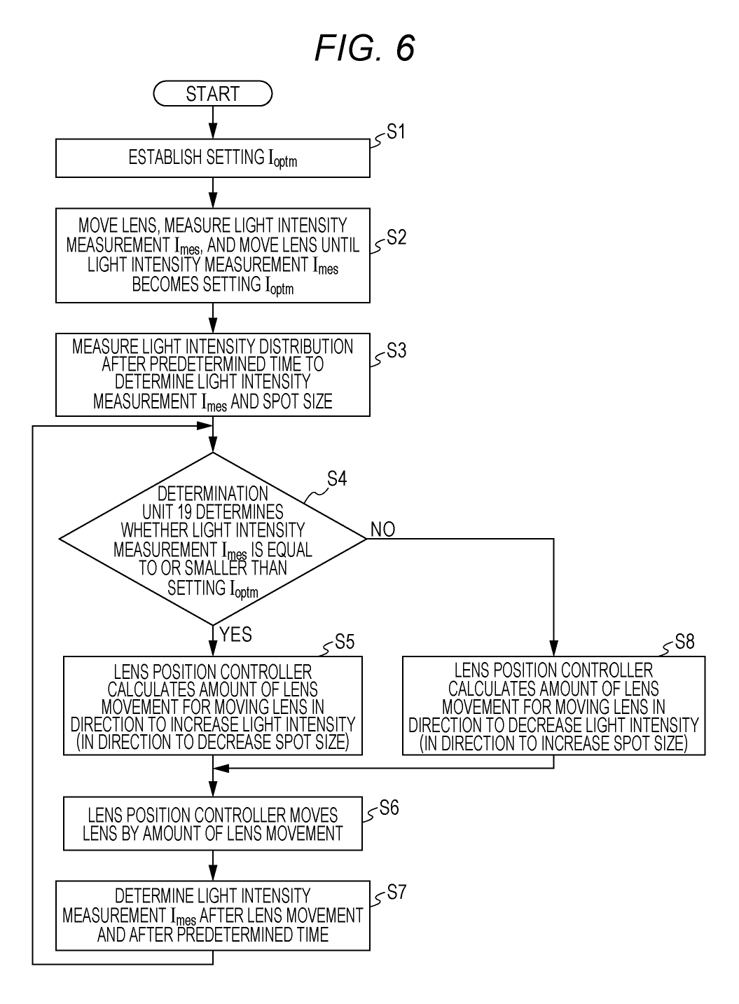

Next, with reference to the flow chart of FIG. 6, a description will be given of a light concentrating method for a photochemical reaction device performed by using light concentrating device 93 for a photochemical reaction device.

First, in step S1, a setting Iₒₚₜₘ of peak intensity of light intensity distribution in electrode 104 of photochemical reaction device 91 is determined, and the setting Iₒₚₜₘ is stored in storage unit 21 from input device 23 or the like as the peak intensity threshold. This setting Iₒₚₜₘ is also used by determination unit 19 in subsequent steps as the peak intensity threshold. As the setting Iₒₚₜₘ, maximum light intensity Iₘₐₓ (for example, 5 W/cm²) may be set that causes occurrence of an abnormal chemical reaction in which electrode 104 of photochemical reaction device 91 undergoes the abnormal chemical reaction and begins to melt. Alternatively, the setting Iₒₚₜₘ may adopt setting of, for example, a value like 1 W/cm² that is average intensity Iₐᵥₑ of sunlight. Alternatively, instead of a value of the maximum light intensity Iₘₐₓ itself, in order to provide some tolerance, the setting Iₒₚₜₘ may adopt setting of a value smaller than the maximum light intensity Iₘₐₓ by a tolerable value.

Then, in step S2, lens position controller 22 drives motor 13 to move lens 10 in optical axis direction Z based on the setting Iₒₚₜₘ stored in storage unit 21, and measures the light intensity measurement Iₘₑₛ of the peak intensity of the light intensity distribution in electrode 104 of photochemical reaction device 91. Lens position controller 22 drives motor 13 to move lens 10 in optical axis direction Z to a position where the light intensity measurement Iₘₑₛ becomes the setting Iₒₚₜₘ. Light intensity distribution detector 17 detects the light intensity distribution, and defines its height as the light intensity measurement Iₘₑₛ of the peak intensity of the light intensity distribution.

Then, in step S3, after a predetermined time since the light intensity measurement Iₘₑₛ in electrode 104 of photochemical reaction device 91 has become the setting Iₒₚₜₘ, camera 16 again measures the peak intensity of the light intensity distribution, and light intensity distribution detector 17 determines the light intensity measurement Iₘₑₛ and outputs the light intensity measurement Iₘₑₛ to determination unit 19.

At this time, measurement of the light intensity measurement Iₘₑₛ is performed by, to begin with, camera 16 picking up and observing transmitted light 92 that passes through electrode 104 of photochemical reaction device 91 to output a picked-up image to light intensity distribution detector 17. Then, light intensity distribution detector 17 determines the peak intensity of the light intensity distribution as the light intensity measurement Iₘₑₛ based on the picked-up image, and outputs information on the determined light intensity distribution to spot size calculator 18. Then, spot size calculator 18 determines the spot size (diameter of transmitted light 92) based on the information about the light intensity distribution. Spot size calculator 18 outputs, to determination unit 19, the spot size determined by spot size calculator 18, and the information on the light intensity measurement Iₘₑₛ that is the peak intensity of the light intensity distribution determined by light intensity distribution detector 17.

Then, in step S4, determination unit 19 determines whether the light intensity measurement Iₘₑₛ is equal to or smaller than the setting Iₒₚₜₘ.

When determination unit 19 determines in step S4 that the light intensity measurement Iₘₑₛ is equal to or smaller than the setting Iₒₚₜₘ, the processing proceeds to step S5. That is, when determination unit 19 determines that the light intensity measurement Iₘₑₛ is equal to or smaller than the setting Iₒₚₜₘ, the light intensity is insufficient and an artificial photosynthesis efficiency is deteriorating, and thus it is necessary to move lens 10 to increase the light intensity. Accordingly, the processing proceeds to step S5, and lens position controller 22 calculates the amount of lens movement for moving lens 10 in a direction to increase the light intensity, in other words, in a direction to decrease the spot size. Specifically, lens position controller 22 determines a difference between the light intensity measurement Iₘₑₛ and the setting Iₒₚₜₘ, and based on the difference, lens position controller 22 calculates the amount of lens movement with reference to storage unit 21. Subsequently, the processing proceeds to step S6.

At this time, lens position controller 22 calculates the amount of lens movement as follows.

First, lens position controller 22 creates in advance a graph or table that represents a relationship among a lens position, the light intensity, and the spot size, and stores the graph or table in storage unit 21. When determination unit 19 determines that the light intensity measurement Iₘₑₛ is equal to or smaller than the setting Iₒₚₜₘ (for example, when determination unit 19 determines that the light intensity measurement Iₘₑₛ is equal to or smaller than the setting lop, and that the difference between the two values is larger than an error range), lens position controller 22 determines the difference between the light intensity measurement Iₘₑₛ and the setting Iₒₚₜₘ based on the light intensity measurement Iₘₑₛ and the setting Iₒₚₜₘ. Then, based on the difference, the spot size at the time of measurement determined by spot size calculator 18, and the position of lens 10 at a time of measurement, lens position controller 22 determines the amount of lens movement with reference to storage unit 21. That is, lens position controller 22 calculates how large the spot size at the time of measurement is to be set from the difference between the light intensity measurement Iₘₑₛ and the setting Iₒₚₜₘ, and determines the position of lens 10 corresponding to the calculated spot size. The amount of lens movement is a difference between the calculated position of lens 10 and the position of lens 10 at the time of measurement. Lens position controller 22 calculates the position of lens 10 at the time of measurement from the spot size calculated by spot size calculator 18, a screw pitch of screw shaft 12, and information on the resolution and rotation angle of encoder 15.

On the other hand, when determination unit 19 determines in step S4 that the light intensity measurement Iₘₑₛ exceeds the setting low, the processing proceeds to step S8. That is, when determination unit 19 determines that the light intensity measurement Iₘₑₛ exceeds the setting Iₒₚₜₘ, the light intensity is excessive, and as described above, damage may occur to electrode 104 of photochemical reaction device 91. Accordingly, it is necessary to move lens 10 to decrease the light intensity. Therefore, the processing proceeds to step S8, and lens position controller 22 calculates the amount of lens movement for moving lens 10 in a direction to decrease the light intensity, in other words, in a direction to increase a spot diameter. Specifically, lens position controller 22 determines the difference between the light intensity measurement Iₘₑₛ and the setting Iₒₚₜₘ, and based on the difference, lens position controller 22 calculates the amount of lens movement with reference to storage unit 21. Subsequently, the processing proceeds to step S6.

Then, in step S6, lens position controller 22 drives motor 13 based on the calculated amount of lens movement to move lens 10 by the amount of lens movement. Subsequently, the processing proceeds to step S7.

Then, in step S7, after a predetermined time since lens 10 has been moved by the amount of lens movement, camera 16 measures the light intensity again, and light intensity distribution detector 17 determines the light intensity measurement Iₘₑₛ and outputs the light intensity measurement Iₘₑₛ to determination unit 19. Subsequently, the processing returns to step S4.

In order to avoid frequent movement of lens 10, when determination unit 19 determines that the light intensity measurement Iₘₑₛ is within a predetermined tolerance even though the light intensity measurement Iₘₑₛ is equal to or smaller than the setting Iₒₚₜₘ, lens 10 may be maintained in a current position without movement. The light intensity may be determined to be insufficient and the above-described lens moving operation may be performed only when determination unit 19 determines that the light intensity measurement Iₘₑₛ is equal to or smaller than the setting Iₒₚₜₘ and is outside the predetermined tolerance.

According to the above-described first embodiment, lens position controller 22 controls motor 13 to move lens 10 so as to decrease occurrence of the abnormal chemical reaction when abnormal chemical reaction detector 20 detects the abnormal chemical reaction. Thus, it is possible to decrease the abnormal chemical reaction that occurs when the intensity of sunlight 90 is too strong for electrode 104 of photochemical reaction device 91.

In the first embodiment, in order to acquire chemical reaction information, image data on the chemical reaction is acquired by using camera 16 which is an example of the photochemical reaction information acquisition unit, and the acquired image data is output to abnormal chemical reaction detector 20 illustrated in FIG. 2. However, the first embodiment is not limited to this example, and in order to acquire chemical reaction information, instead of using the image data acquired by camera 16, an ammeter may be inserted between working electrode terminal 110 and counter electrode terminal 111 as another example of the photochemical reaction information acquisition unit, and a current value Aₘₑₛ of the ammeter may be output to abnormal chemical reaction detector 20 as the chemical reaction information.

That is, the current value Aₘₑₛ may directly be input into determination unit 19 in abnormal chemical reaction detector 20. When determination unit 19 determines that the current value Aₘₑₛ exceeds a current value threshold, lens 10 is moved in a direction away from electrode 104, and light concentration by lens 10 is eased. Thereby, the chemical reaction can escape from an abnormal state and can be restored to a normal state, at this time lens movement may be suspended, and the chemical reaction can maintain the normal state.

Instead of the above-described configuration in which the ammeter is inserted, if another configuration in which an electrometer is used for measuring a potential difference between working electrode terminal 110 and counter electrode terminal 111 as another example of the photochemical reaction information acquisition unit is employed, a similar effect is obtained.

In the first embodiment in which transmitted light 92 that passes through electrode 104 is observed with camera 16 that is an image pickup device, it is also effective to install camera 16 on a side on which light is incident, that is, on a side where lens 10 is disposed, and to observe reflected and scattered light from electrode 104 instead of the transmitted light. In this case, intensity of scattered light and a range in which light is scattered, that is, a scattering region are observed simultaneously. The intensity of scattered light may be defined as Iₘₑₛ and the scattering region may replace the above-mentioned spot size.

In this case, a position to install camera 16 is a place where camera 16 is directed to a side on which lens 10 is disposed via arm 16a, as illustrated in FIG. 1B.

### Second Embodiment

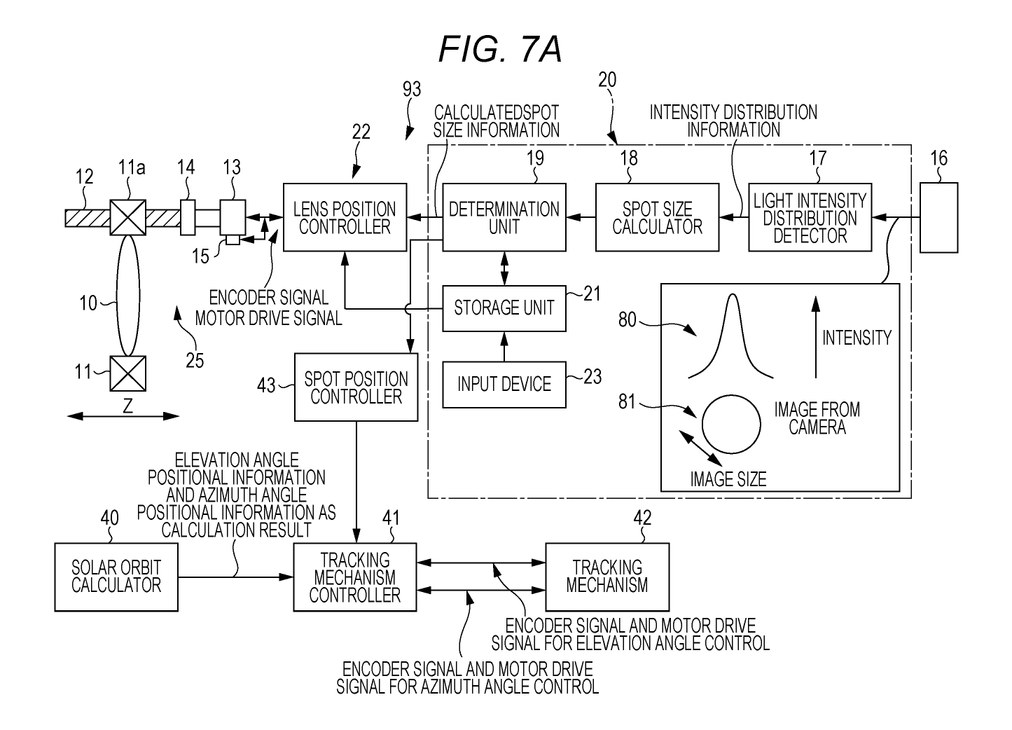

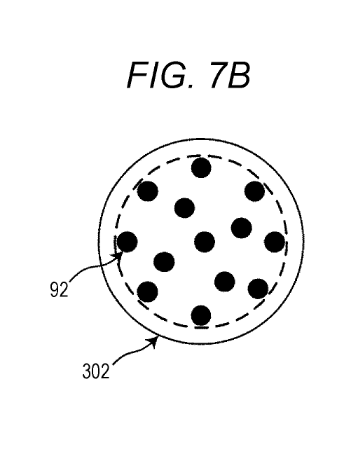

Next, a description will be given of a light concentrating device for a photochemical reaction device according to a second embodiment of the present disclosure. As illustrated in FIG. 7A, the light concentrating device for a photochemical reaction device according to the second embodiment differs from the light concentrating device for a photochemical reaction device according to the first embodiment in that the light concentrating device for a photochemical reaction device according to the second embodiment includes solar orbit calculator 40, sunlight tracking mechanism 42, tracking mechanism controller 41, and spot position controller 43.

As is known, solar orbit calculator 40 calculates a solar orbit, and outputs elevation angle positional information and azimuth angle positional information to tracking mechanism controller 41 as a calculation result.

Here, examples of known configurations for tracking the sun include a configuration in which a solar tracking device includes a sensor for detecting sunlight and tracks the sun based on intensity of the sunlight detected by the sensor. That is, the configuration assumes that the sun is located in a direction in which the sunlight detected by the sensor becomes strongest, and optical axis direction Z of lens 10 is directed in the direction. In addition, another configuration is also known in which solar directions (azimuth angle and elevation angle) are calculated based on date and time, and optical axis direction Z of lens 10 is directed in the calculated directions. Moreover, a configuration which is a combination of these two configurations is also known. Solar orbit calculator 40 outputs, to tracking mechanism controller 41, the elevation angle positional information and azimuth angle positional information that are determined by these configurations for tracking the sun.

Tracking mechanism controller 41 drives and controls tracking mechanism 42 based on the elevation angle positional information and azimuth angle positional information that are output from solar orbit calculator 40.

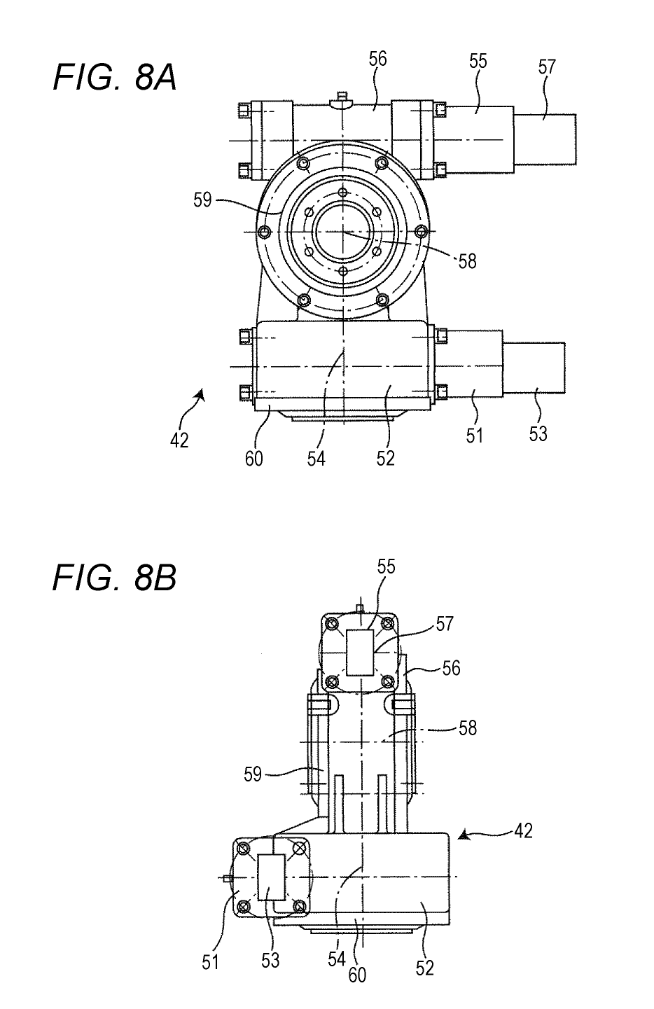

As illustrated in FIG. 8A and FIG. 8B, tracking mechanism 42 includes azimuth angle motor 51, azimuth angle worm gear 52, azimuth angle rotary encoder 53, azimuth angle rotation mechanism 59, elevation angle motor 55, elevation angle worm gear 56, elevation angle rotary encoder 57, and elevation angle rotation mechanism 60. The light concentrating device for a photochemical reaction device according to the first embodiment is supported on an upper part of azimuth angle rotation mechanism 59 (see FIG. 1A).

Azimuth angle motor 51 is rotatively driven in a forward and reverse direction under the control of tracking mechanism controller 41. Azimuth angle worm gear 52 is rotated forwardly and reversely by azimuth angle motor 51 being rotatively driven in a forward and reverse direction, and azimuth angle rotation mechanism 59 screwed into azimuth angle worm gear 52 rotates forwardly and reversely around azimuth angle central axis 54. Forward and reverse rotation of azimuth angle motor 51 is detected by azimuth angle rotary encoder 53, and is output to tracking mechanism controller 41.

Elevation angle motor 55 is rotatively driven in a forward and reverse direction under the control of tracking mechanism controller 41. Elevation angle worm gear 56 is rotated forwardly and reversely by elevation angle motor 55 being rotatively driven in a forward and reverse direction, and elevation angle rotation mechanism 60 screwed into elevation angle worm gear 56 rotates forwardly and reversely around elevation angle central axis 58. Forward and reverse rotation of elevation angle motor 55 is detected by elevation angle rotary encoder 57, and is output to tracking mechanism controller 41.

Spot position controller 43 calculates elevation angle positional information and azimuth angle positional information about tracking mechanism 42 such that a spot of transmitted light 92 of the sun moves within effective reaction region 302 of electrode 104 of photochemical reaction device 91 (in a range that does not extend off effective reaction region 302), and outputs a calculation result to tracking mechanism controller 41. Based on the elevation angle positional information and azimuth angle positional information that are input from spot position controller 43, tracking mechanism controller 41 controls an operation of tracking mechanism 42, and moves the spot of transmitted light 92. Spot position controller 43 moves the spot of transmitted light 92 of the sun randomly (see FIG. 7B), spirally, or along a circumference within effective reaction region 302 of electrode 104. However, a black circle in FIG. 7B indicates a position where the spot of transmitted light 92 can be disposed. FIG. 7B does not mean that transmitted light 92 is simultaneously disposed in all the black circles within effective reaction region 302 of electrode 104. FIG. 7B means that transmitted light 92 is disposed only in one of the black circles. Spiral movement of the spot means a state where the spot of transmitted light 92 moves, for example, rotating from a central position of effective reaction region 302 of electrode 104 toward a periphery to draw a swirl. Thus, by movement of the spot of transmitted light 92 with time rather than the spot always disposed in an identical position, chemical reactions occur not only in a specific position within effective reaction region 302 of electrode 104, but chemical reactions occur uniformly within effective reaction region 302. This can extend a life of electrode 104.

Spot position controller 43 moves the spot of transmitted light 92 of the sun within effective reaction region 302 of electrode 104 of photochemical reaction device 91 with timing that is not limited to a case where the spot is always moved (at predetermined time intervals, for example, every two days, regardless of presence of an alarm signal). For example, when determination unit 19 according to the first embodiment determines that detected peak intensity of light intensity distribution exceeds a peak intensity threshold, determination unit 19 may output an alarm signal to spot position controller 43, and the spot may be moved when the alarm signal is input from determination unit 19 into spot position controller 43.

Such spot position control based on the alarm signal will be described below.

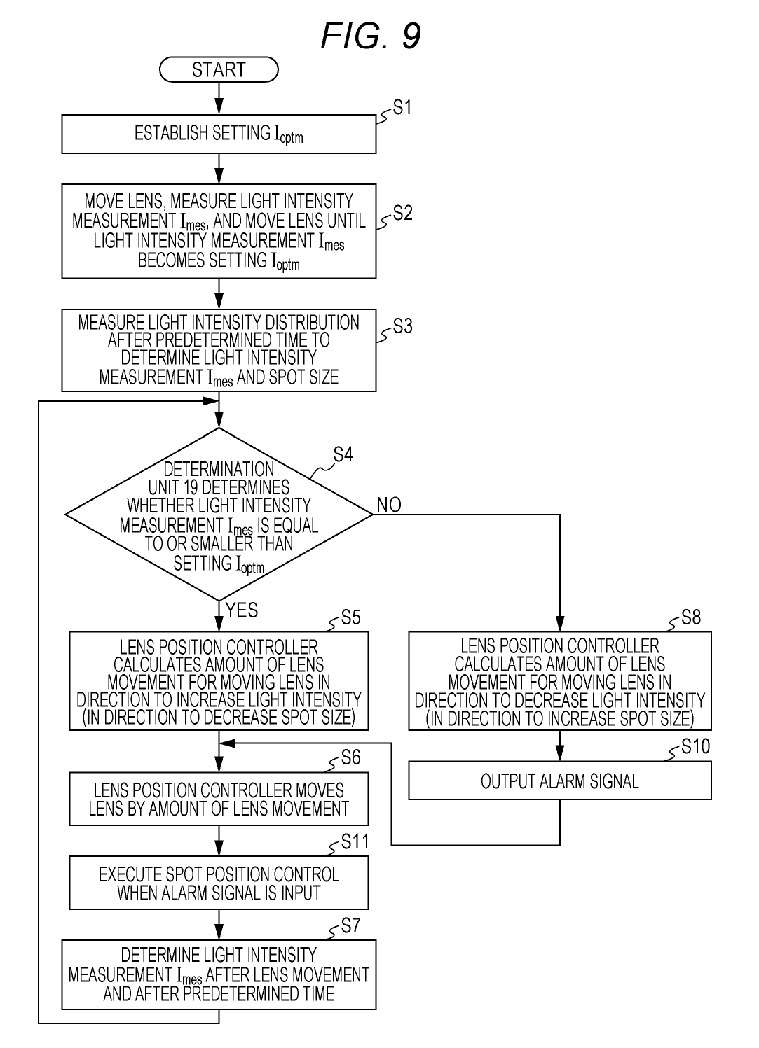

That is, after it is determined in step S4 that the detected peak intensity of the light intensity distribution exceeds the peak intensity threshold and the processing proceeds to step S8, as illustrated in FIG. 9, the processing proceeds to step S10.

In step S10, determination unit 19 outputs the alarm signal to spot position controller 43. Subsequently, the processing proceeds to step S6.

After step S6 is executed as in the first embodiment, the processing proceeds to step S11.

In step S11, when the alarm signal is input from determination unit 19 into spot position controller 43, the above-described spot position control is executed. Specifically, spot position controller 43 calculates the elevation angle positional information and azimuth angle positional information about tracking mechanism 42 such that the spot of transmitted light 92 of the sun moves randomly, spirally, or along the circumference within effective reaction region 302 of electrode 104 of photochemical reaction device 91. Spot position controller 43 then outputs a calculation result to tracking mechanism controller 41. Based on the elevation angle positional information and azimuth angle positional information that are input from spot position controller 43, tracking mechanism controller 41 controls the operation of tracking mechanism 42 to move the spot of transmitted light 92 randomly, spirally, or along the circumference. Subsequently, the processing proceeds to step S7.

According to the second embodiment, by movement of the spot of transmitted light 92 with time rather than the spot always disposed in an identical position within effective reaction region 302 of electrode 104, chemical reactions occur not only in a specific position within effective reaction region 302 of electrode 104, but chemical reactions occur uniformly within effective reaction region 302. This can extend the life of electrode 104.

According to the second embodiment, in order to detect a chemical reaction state, image data on the chemical reaction is acquired by using camera 16 and the acquired image data is output to abnormal chemical reaction detector 20 illustrated in FIG. 7A. However, in order to detect the chemical reaction state, instead of using the image data acquired by camera 16, an ammeter may be inserted between working electrode terminal 110 and counter electrode terminal 111, and a current value Aₘₑₛ of the ammeter may be output to abnormal chemical reaction detector 20.

That is, the current value Aₘₑₛ may directly be input into determination unit 19 within abnormal chemical reaction detector 20. In this case, the alarm signal is output from determination unit 19 into spot position controller 43 at a timing when the current value Aₘₑₛ exceeds the threshold.

If another configuration in which an electrometer is used for measuring a potential difference between working electrode terminal 110 and counter electrode terminal 111 is employed instead of the above-described configuration in which the ammeter is inserted, a similar effect is obtained.

### Third Embodiment

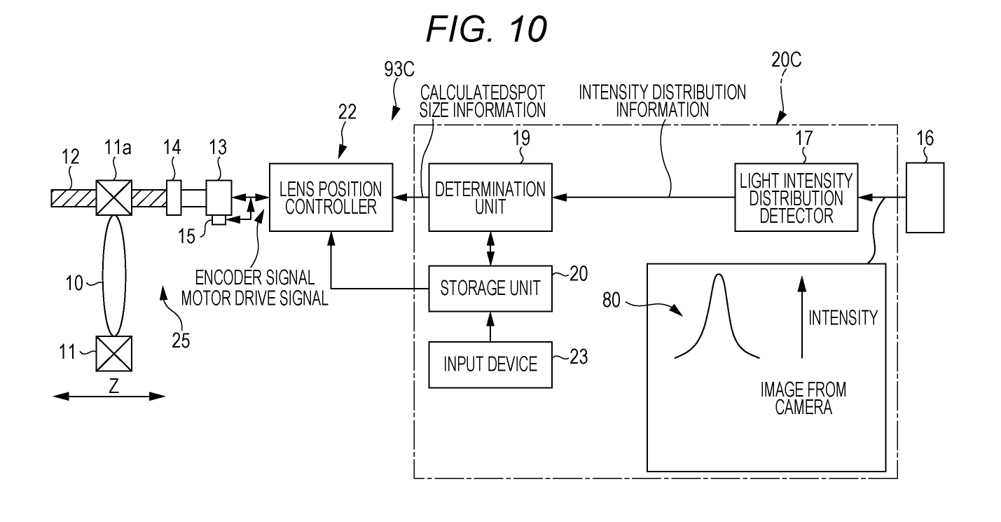

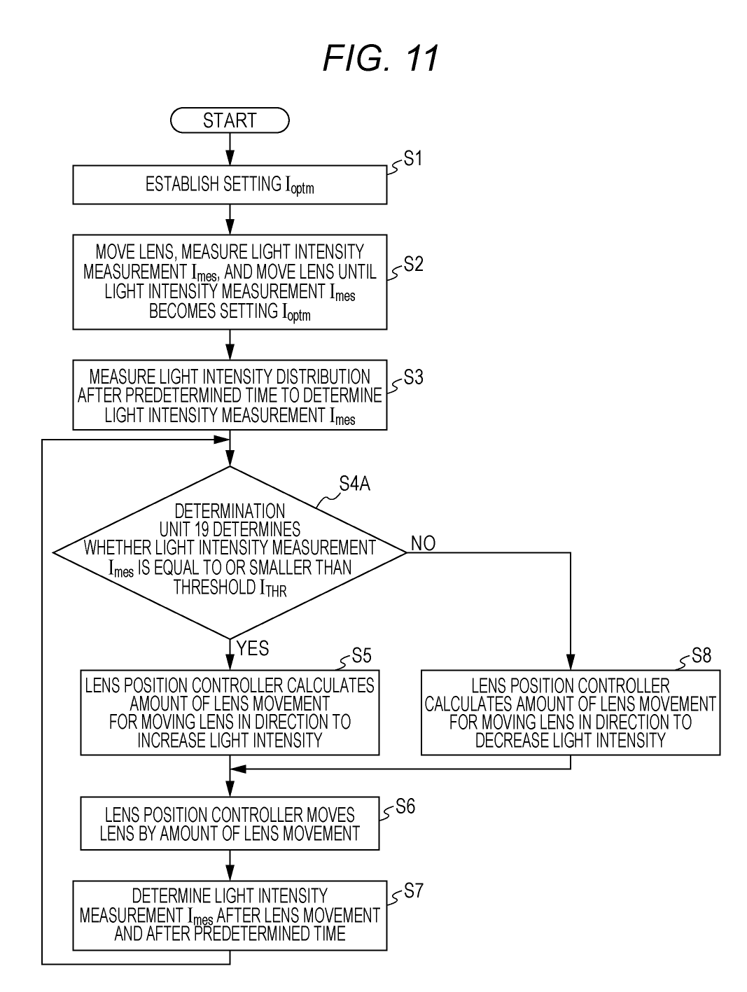

FIG. 10 is a detailed block diagram of a light concentrating device for a photochemical reaction device according to a third embodiment of the present disclosure. FIG. 11 is a flow chart for describing a light concentrating method for a photochemical reaction device performed by the light concentrating device for a photochemical reaction device according to the third embodiment of the present disclosure. In the light concentrating device for a photochemical reaction device according to the third embodiment, a spot size calculator is omitted in abnormal chemical reaction detector 20C of light concentrating device 93C for a photochemical reaction device of the first embodiment, and determination unit 19 determines whether a light intensity measurement Iₘₑₛ is equal to or smaller than a peak intensity threshold I_{THR}, the light intensity measurement Iₘₑₛ being peak intensity (maximum light intensity) of light intensity distribution detected by light intensity distribution detector 17 (see step S4A).

Accordingly, in the flow chart of FIG. 11, after operations similar to operations of the first embodiment are executed in step S1 to step S3, the processing proceeds to step S4A.

In step S4A, when determination unit 19 determines that the light intensity measurement Iₘₑₛ is equal to or smaller than the peak intensity threshold I_{THR}, the processing proceeds to step S5. That is, when determination unit 19 determines that the light intensity measurement Iₘₑₛ is equal to or smaller than the peak intensity threshold I_{THR}, the light intensity is insufficient and an artificial photosynthesis efficiency is deteriorating, and thus it is necessary to move lens 10 to increase the light intensity. Accordingly, the processing proceeds to step S5, and lens position controller 22 calculates an amount of lens movement for moving lens 10 in a direction to increase the light intensity, in other words, in a direction to decrease a spot size. Specifically, lens position controller 22 determines a difference between the light intensity measurement Iₘₑₛ and the peak intensity threshold I_{THR}, and based on the difference, lens position controller 22 calculates the amount of lens movement with reference to storage unit 21. Subsequently, the processing proceeds to step S6.

On the other hand, when determination unit 19 determines in step S4A that the light intensity measurement Iₘₑₛ exceeds the peak intensity threshold I_{THR}, the processing proceeds to step S8. That is, when determination unit 19 determines that the light intensity measurement Iₘₑₛ exceeds the peak intensity threshold I_{THR}, the light intensity is excessive, and as described above, damage may occur to electrode 104 of photochemical reaction device 91. Accordingly, it is necessary to move lens 10 to decrease the light intensity. Therefore, the processing proceeds to step S8, and lens position controller 22 calculates the amount of lens movement for moving lens 10 in a direction to decrease the light intensity, in other words, in a direction to increase a spot diameter. Specifically, lens position controller 22 determines the difference between the light intensity measurement Iₘₑₛ and the peak intensity threshold I_{THR}, and based on the difference, lens position controller 22 calculates the amount of lens movement with reference to storage unit 21. Subsequently, the processing proceeds to step S6.

Operations of other steps, such as step S6, are similar to operations of the first embodiment.

According to the third embodiment, it is possible to omit the spot size calculator and to achieve more compact structure.

The present disclosure has been described based on the first to third embodiments and variations, but the present disclosure is of course not limited to the above-described first to third embodiments and variations. The following case is also included in the present disclosure.

Specifically, a part or all of components describe above are a computer system that includes a microprocessor, a ROM, a RAM, a hard disk unit, a display unit, a keyboard, a mouse, and the like. A computer program is stored in the RAM or hard disk unit. Each component performs its function by the microprocessor operating in accordance with the computer program. Here, the computer program is configured by a combination of a plurality of instruction codes that represent commands for the computer to perform a predetermined function.

Each component can be implemented by, for example, a program execution unit, such as a CPU, reading and executing the software program recorded in a recording medium, such as a hard disk or a semiconductor memory. The following program is the software that implements a part or all of the components that constitute a part of the light concentrating device in the above embodiments or variations. That is, this program is a control program for causing a computer to function as an abnormal chemical reaction detector for detecting presence of an abnormal chemical reaction on the electrode based on information regarding the photochemical reaction acquired by the photochemical reaction information acquisition unit, and as a lens position controller for controlling the lens movement device to move the lens so as to decrease occurrence of the abnormal chemical reaction when the abnormal chemical reaction detector detects the abnormal chemical reaction.

This program may be executed by a download from a server or the like, and may be executed by a read of the program recorded in a predetermined recording medium (for example, an optical disc, such as a CD-ROM, a magnetic disk, a semiconductor memory, and the like).

The computer that executes this program may be one unit, and may be two units or more. That is, central processing may be performed, or distributed processing may be performed.

Suitable combination of arbitrary embodiments or variations among the above-described various embodiments or variations can provide effect of each embodiment or variation.

In a light concentrating device for a photochemical reaction device according to the present disclosure, a lens position controller controls a lens movement device to move a lens so as to decrease occurrence of the abnormal chemical reaction when an abnormal chemical reaction detector detects an abnormal chemical reaction. Thus, it is possible to properly produce a photochemical reaction in the photochemical reaction device. The light concentrating device for a photochemical reaction device is therefore useful as a light concentrating device for a photochemical reaction device of a photochemical reaction device that performs photochemical reactions using sunlight.

### REFERENCE SIGNS LIST

10: lens
11: lens holder
11a: junction part
12: screw shaft
13: motor
14: coupling
15: encoder
16: camera
17: light intensity distribution detector
18: spot size calculator
19: determination unit
20, 20C: abnormal chemical reaction detector
21: storage unit
22: lens position controller
23: input device
25: lens movement device
40: solar orbit calculator
41: tracking mechanism controller
42: tracking mechanism
43: spot position controller
51: azimuth angle motor
52: azimuth angle worm gear
53: azimuth angle rotary encoder
54: azimuth angle central axis
55: elevation angle motor
56: elevation angle worm gear
57: elevation angle rotary encoder
58: elevation angle central axis
59: azimuth angle rotation mechanism
60: elevation angle rotation mechanism
80: example of observation of light intensity distribution
81: example of observation of spot
90: sunlight
91: photochemical reaction device
92: transmitted light
93, 93C: light concentrating device for photochemical reaction device
101: working electrode
102: cathode compartment
104: electrode
104A, 104B, 104C, 104D: anode electrode
105: anode compartment
106: solid electrolyte membrane
107: first electrolytic solution
108: second electrolytic solution
109: pipe
110: working electrode terminal
111: counter electrode terminal
112: lead wire
211: first semiconductor layer
212: second semiconductor layer
213: AlGaN layer
214: n-type GaN layer
215: conductive base material
216: electrode part
217: terminal electrode part
302: nitride semiconductor region
303: metallic wiring

What is claimed is:

1. A light concentrating device for a photochemical reaction device comprising:
a lens configured to concentrate sunlight on an electrode of a photochemical reaction device;
a lens movement device configured to move the lens in an optical axis direction;
a photochemical reaction information acquisition unit configured to acquire information regarding a photochemical reaction that occurs on the electrode of the photochemical reaction device;
an abnormal chemical reaction detector configured to detect presence of an abnormal chemical reaction on the electrode based on the information regarding the photochemical reaction acquired by the photochemical reaction information acquisition unit; and
a lens position controller configured to control the lens movement device to move the lens so as to decrease occurrence of the abnormal chemical reaction when the abnormal chemical reaction detector detects the abnormal chemical reaction.

2. The light concentrating device for a photochemical reaction device according to claim 1, wherein
the photochemical reaction information acquisition unit is formed of an image pickup device configured to pick up an image of the sunlight concentrated on the electrode and to acquire information on the picked-up image of the sunlight as the information regarding the photochemical reaction,
the abnormal chemical reaction detector comprises:
a light intensity distribution detector configured to detect light intensity distribution of the sunlight based on the information on the image picked up by the image pickup device; and
a determination unit configured to determine whether peak intensity of the light intensity distribution detected by the light intensity distribution detector exceeds a peak intensity threshold, and
when the determination unit determines that the peak intensity of the light intensity distribution exceeds the peak intensity threshold, the abnormal chemical reaction detector determines that the abnormal chemical reaction is detected, and the lens position controller controls the lens movement device to move the lens so as to decrease the peak intensity of the light intensity distribution.

3. The light concentrating device for a photochemical reaction device according to claim 1, wherein
the photochemical reaction information acquisition unit is formed of an ammeter for measuring a current value that occurs on the electrode to acquire the measured current value as the information regarding the photochemical reaction,
the abnormal chemical reaction detector comprises a determination unit configured to determine whether the current value measured by the ammeter exceeds a current value threshold, and
when the determination unit determines that the current value exceeds the current value threshold, the abnormal chemical reaction detector determines that the abnormal chemical reaction is detected, and the lens position controller controls the lens movement device to move the lens so as to decrease the current value of the light intensity distribution.

4. The light concentrating device for a photochemical reaction device according to claim 2, wherein
the abnormal chemical reaction detector further comprises a spot size calculator configured to calculate a spot size of the sunlight on the electrode based on the image picked up by the image pickup device, and
when the determination unit determines that the peak intensity of the light intensity distribution exceeds the peak intensity threshold, the abnormal chemical reaction detector determines that the abnormal chemical reaction is detected, and the lens position controller controls the lens movement device to move the lens so as to decrease the peak intensity of the light intensity distribution such that the spot size of the sunlight on the electrode becomes larger than the calculated spot size.

5. The light concentrating device for a photochemical reaction device according to claim 1, further comprising:
a tracking mechanism configured to support the photochemical reaction device, the lens, and the lens movement device, and to move an elevation angle and an azimuth angle in alignment with a position of the sun;
a tracking mechanism controller configured to control the tracking mechanism to move the elevation angle and azimuth angle of the tracking mechanism so as to align the photochemical reaction device, the lens, and the lens movement device with the position of the sun; and
a spot position controller configured to control the tracking mechanism via the tracking mechanism controller to move the elevation angle and azimuth angle of the tracking mechanism such that a spot of the sunlight of the sun on the electrode moves within an effective reaction region of the electrode of the photochemical reaction device.

6. The light concentrating device for a photochemical reaction device according to claim 5, wherein
the spot position controller controls the tracking mechanism such that the spot of the sunlight of the sun on the electrode moves randomly or spirally within the effective reaction region of the electrode.

7. A non-transitory computer-readable recording medium having stored thereon a control program for controlling an operation of a light concentrating device for a photochemical reaction device,
the light concentrating device for a photochemical reaction device comprising:
a lens configured to concentrate sunlight on an electrode of the photochemical reaction device;
a lens movement device configured to move the lens in an optical axis direction; and
a photochemical reaction information acquisition unit configured to acquire information regarding a photochemical reaction that occurs on the electrode of the photochemical reaction device,
the control program causing a computer to function as:
an abnormal chemical reaction detector configured to detect presence of an abnormal chemical reaction on the electrode based on the information regarding the photochemical reaction acquired by the photochemical reaction information acquisition unit; and
a lens position controller configured to control the lens movement device to move the lens so as to decrease occurrence of the abnormal chemical reaction when the abnormal chemical reaction detector detects the abnormal chemical reaction.
